(19) United States
(12) Patent Application Publication
(10) Pub. No.: US 2025/0389354 A1
(43) Pub. Date: Dec. 25, 2025

(54) SYSTEM AND METHOD FOR SEALING A FLUID PATHWAY

(71) Applicant: Frederick Rezaei, Scottsdale, AZ (US)

(72) Inventor: Frederick Rezaei, Scottsdale, AZ (US)

(21) Appl. No.: 18/715,565

(22) PCT Filed: May 4, 2023
(86) PCT No.: PCT/US2023/021065

§ 371 Date: Sep. 8, 2025

Related U.S. Application Data
(60) Provisional application No. 63/340,102, filed on May 10, 2022.

(51) Int. Cl. F16L 17/08; F16J 15/06; F16L 17/03; F16L 17/073

(52) U.S. Cl. CPC F16L 17/08; F16J 15/06; F16L 17/03; F16L 17/073

(57) ABSTRACT

A ring-shaped gasket has a body, and a wing that deflects at least a portion of the stress of compression from the axial center of the ring seal. The wing compresses in both the axial and the radial direction when tightened between seal surfaces. When the wing is further compressed, the portion of the wing contacting the seal surface moves in a radial direction from farther away from the center of the ring seal to closer to the center of the ring seal. The outer radial surface of the ring seal has a wing trough and a central trough separated by a peak. The troughs may have a V-shape a U-shape, or may have a regular arrangement of blind cavities projecting into either one or both of the axial end surfaces.

### CROSS REFERENCE TO RELATED APPLICATION

This application claims benefit from currently pending U.S. Provisional Application No. 63/340,102 titled “System and Method for Sealing a Fluid Pathway” and having a filing date of May 10, 2022, all of which is incorporated by reference herein.

### BACKGROUND OF THE INVENTION

### Technical Field

This invention relates to primarily metallic gaskets that seal fluid couplings.

### Background Art

Embodiments of the present invention are related to malleable, primarily metallic, gaskets for sealing joints between portions of a fluid pathway. Fluid pathways found among industrial equipment producing many products including semiconductors may be subjected to vacuum, pressure, or purity requirements. Fluid pathways among elements intended for manipulating process materials within semiconductor manufacturing equipment usually require attention to maintaining high purity of the delivered reactants and typically have a much smaller cross-section than other fluid pathways. Semiconductor production environments can represent some of the harshest environments that O-ring seals can encounter and processes can be very diverse from high heat, aggressive plasma, hot wet chemicals and amines, and remote NF3 cleans. In many cases practitioners have found metallic gaskets provide superior performance, particularly regarding diffusion of process fluid or contaminants through the gasket and consequent resistance to undesirable leakage.

One known type of fluid pathway joint uses a ring-shaped gasket, typically annularly shaped, defining an axially aligned hole for fluid (liquid or gas) passage, two axially opposed end surfaces, a radial inner surface, and a radial outer surface. A simplistic ring seal has planar end surfaces and smooth circular radial inner and outer surfaces that define the inner diameter (ID) and outer diameter (OD) of the ring seal. Metal seals provide plastic deformation to achieve extraordinarily low leak rates between substantially planar parallel surfaces.

A commonly used sealing ring is circular and has a radial cross-section of a “C” shape. These “C seals” are usually constructed with the open side of the C construction facing away from the center of the ring. As two parallel surfaces are brought together with the C seal in the middle, the C seal is compressed with the open side of the C cross-section closing during compression. The ductile properties of the seal permit plastic deformation to occur without damaging the mating surface. To increase the elastic recovery of the seal or to improve placement and prevent unwanted movement of the seal, some C seals are provided with retainer sleeves or retainer rings.

Some seals offer different radial cross-sections to obtain varying sealing capabilities for different fluid flow environments. The annular projections are urged axially toward each other during compression causing permanent plastic deformation of the ductile metallic gasket creating a seal that will resist leakage of even difficult to contain fluids. As an example, U.S. Pat. No. 6,357,760 to Doyle provides a C shaped seal that also includes a plurality of bores which project radially inward from the radial outer surface toward the radial inner surface. The projection of the bores through the ring seal form sidewalls which project between the axial end surfaces and radially from the ring seal's radial outer surface towards the ring seal's radial inner surface. The addition of the bores to the ring seal increases the ring seal's deformation during sealing compression, while the sidewalls provide elastic recovery of the ring seal during repeated cycles of compression and decompression.

Despite their advantages, many of these seals include sharp sealing edges and sealing surfaces, unprotected sealing edges that can scratch during handling and installation, and metal flakes may be found at cross machining between the hole and the outer diameter groove. Overly complex cross section can demand precise machining and may including too much material leading to high costs. Conventional seals struggle to handle heat over 150 degrees C.

So as to reduce the complexity and length of the Detailed Specification, and to fully establish the state of the art in certain areas of technology, Applicant(s) herein expressly incorporate(s) by reference all of the following materials identified in each numbered paragraph below. The incorporated materials are not necessarily “prior art” and Applicant(s) expressly reserve(s) the right to swear behind any of the incorporated materials.
U.S., U.S. Pat. No. 6,357,760 to Doyle
U.S. Pat. No. 11,255,433 to Kim Ngoc Vu

Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), applicant(s) will amend the specification to expressly recite the essential material that is incorporated by reference as allowed by the applicable rules.

### BRIEF SUMMARY OF THE INVENTION

The present invention provides among other things a ring seal for connecting devices for processing gas and fluid to prevent them from leaking potentially toxic and corrosive gases, liquids, or other fluids

It is thus an object of the present invention to provide very repeatable, high quality, inexpensive and reliable ring seals for providing a seal between two planar surfaces.

It is an additional object of the present invention to provide a ring seal which provides significant ductility to provide a substantially leakproof seal.

It is another object of the present invention to provide a ring seal which provides substantial elastic recovery so that the seal can undergo a substantial number of cycles, compression and decompression, and still provide a substantially leakproof seal.

It is still another object of the present invention to provide a ring seal which does not form a concentric chamber when compressed to create a seal that exhibits the characteristics of a virtual leak.

It is another object of the present invention to provide a ring seal which is simple to manufacture and which can be constructed in a variety of sizes and dimensions.

It is another object of the invention to provide a ring seal that can meet temperature requirements over 250 degrees C.

It is another object of the invention to reduce material requirements for a ring seal by 20%-30% by using a retainer as a centering device.

It is another object of the invention to move the flexing of the ring seal from the axial periphery of the ring seal to the center of the seal where the retainer is holding the seal in place.

It is yet another object of the invention to spread stress in the ring seal to reduce metal fatigue and allow greater endurance of the ring seal.

It is still another object of the invention to allow the ring seal to compress initially to affect a seal and to further flex during intermittent heat and vibration stressors.

It is an additional object of the present invention to provide a ring seal with an increased sealing surface area.

It is an additional object of the present invention to provide a ring seal with a protective lip.

It is an additional object of the present invention to provide a progressive compression method that gradually increases sealing surface area with a straight wall ID bore.

It is an additional object of the present invention to provide a ring seal that uses less material.

It is an additional object of the present invention to provide a ring seal with an all turning process with simple standard tooling and no grooving or milling process.

It is an additional object of the present invention to provide a ring seal with flexible compression.

It is an additional object of the present invention to provide a self-aligning ring seal.

The above and other objects may be achieved using devices involving a ring-shaped gasket for sealing opposed fluid conduit ports, such as those found a fluid delivery system, such as a semiconductor gas panel, a petrochemical production or distribution system, etc. The gasket has a body, pierced through by a hole creating a fluid pathway and defining a radial inner surface, and a radial outer surface. The ring seal also includes a first and second axially end surfaces which are intended to engage the opposing parallel surfaces between which the sealing joint is intended to be located. a first axial end surface and a second axial end surface. At least one of the first and second axial end surfaces has a stress concentration feature or wing radially adjacent to a gasket sealing region, the gasket sealing region constructed and arranged to be in contact with a face surface of a corresponding fluid conduit port. The wing deflects at least a portion of the stress of compression from the axial center of the ring seal. The wing may be shaped such that compression of the wing by the seal surface compresses the wing in both the axial and the radial direction. When the wing is further compressed, the portion of the wing contacting the seal surface moves in a radial direction from farther away from the center of the ring seal to closer to the center of the ring seal.

In an embodiment the outer radial surface of the ring seal comprises a wing trough and a central trough separated by a peak. In some embodiments, at least one of the troughs has a V-shape and in other embodiments, one or more of the troughs has a U-shape.

In yet another embodiment the wing comprises a regular arrangement of blind cavities projecting into either one or both of the axial end surfaces. In another embodiment the regularly arranged stress concentrating blind cavities undercut the wing. In another embodiment the circumferential phase relationship of the blind cavities may be coincident or interposed in anti-phase.

The ring-shaped gasket of the various embodiments described herein may be formed of a malleable material. The malleable material can include a unitary metallic material selected from the group consisting of a stainless steel alloy, a chromium alloy, a nickel alloy, commercially pure nickel, a copper alloy, and commercially pure copper, a unitary metallic material substantially identical to type 316 series stainless steel alloy, a unitary polymer material selected from the group consisting of polypropylene (PP), polyvinylidene fluoride (PVDF), perfluoroalkoxy polymer (PFA), polytetrafluoroethylene (PTFE), polychlorotrifluoroethylene (PCTFE), and polyimide, or a unitary polymer material substantially identical to polyimide.

The above and other objects may be achieved using methods involving forming a high purity fluid joint in a fluid delivery system having a first system body with a first body face and a second system body with a second body face. The first and second system bodies each have a cutout to create a seal cavity to accommodate a ring gasket, and each cutout has a flat surface to engage the ring gasket to affect the seal.

The ring gasket has an annularly shaped body with a center hole for permitting the passage of gases or fluids, a radial inner surface, a radial outer surface, a central trough, and a wing comprising a sealing surface, an apex where the radial inner surface intersects the radial outer surface, and a wing trough on the radial outer surface of the wing that is separated from the central trough by a peak. The ring gasket is place within one of the cutouts so that it resides in the seal cavity when the bodies are affixed together.

A retainer is secured to at least one of the first system body and the second system body, such that the retainer resides in the central trough of the ring gasket when the bodies are sealed together. The first system body is secured to the second system body such that the ring gasket is compressed between the first seal surface and the second seal surface.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF THE SEVERAL VIEWS OF THE DRAWINGS

A more complete understanding of the present invention may be derived by referring to the detailed description when considered in connection with the following illustrative figures. In the figures, like reference numbers refer to like elements or acts throughout the figures.

FIG. 1 depicts a perspective view of a ring seal of one or more embodiments of the invention.

FIG. 2 depicts a cutaway view of the ring seal of FIG. 1.

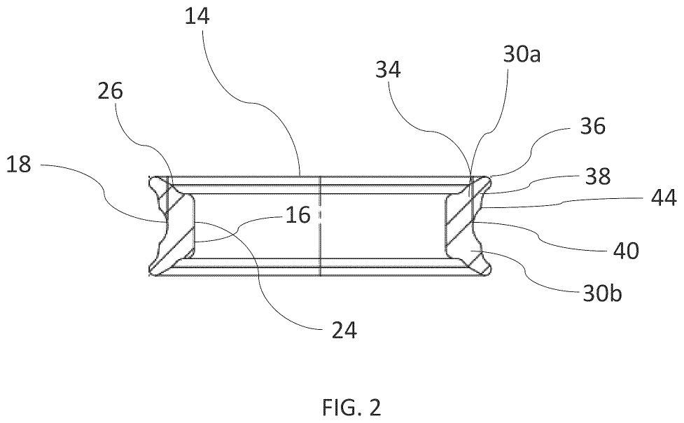

FIG. 3 depicts the cutaway view of the ring seal of FIG. 2 placed in a fluid delivery system according to one or more embodiments of the invention.

FIG. 4 depicts a perspective cutaway view of the ring seal in use in a fluid delivery system according to one or more embodiments of the invention.

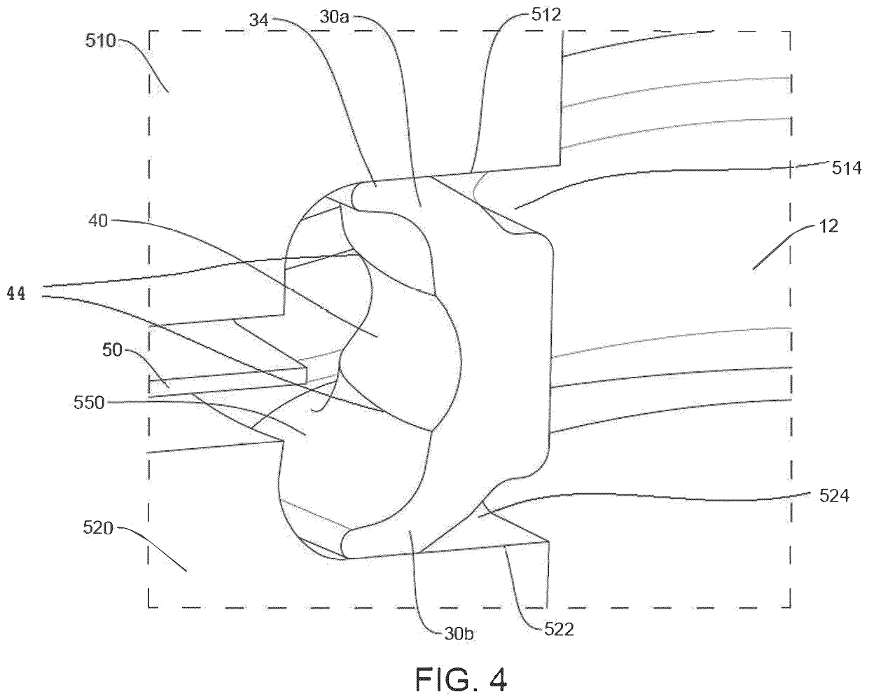

FIG. 5 depicts a graphical illustration of stress on a cutaway view of the ring seal according to one or more embodiments of the invention.

Elements and acts in the figures are illustrated for simplicity and have not necessarily been rendered according to any particular sequence or embodiment.

### DETAILED DESCRIPTION OF THE INVENTION

In the following description, and for the purposes of explanation, numerous specific details are set forth to provide a thorough understanding of the various aspects of the invention. It will be understood, however, by those skilled in the relevant arts, that the present invention may be practiced without these specific details. In other instances, known structures and devices are shown or discussed more generally to avoid obscuring the invention. In many cases, a description of the operation is sufficient to enable one to implement the various forms of the invention, particularly when the operation is to be implemented in software. It should be noted that there are many different and alternative configurations, devices, and technologies to which the disclosed inventions may be applied. The full scope of the inventions is not limited to the examples that are described below.

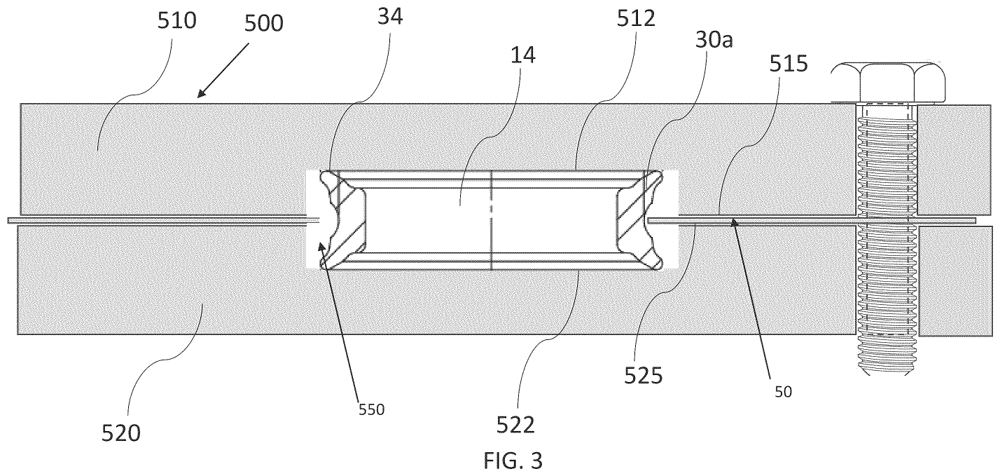

In one application of the invention, a ring seal 10 is provided to seal opposed fluid conduit ports in a fluid delivery system 500 comprising a first system body 510 having a first planar seal face 512 to be joined to a second system body 520 having a second planar seal face 522. As best shown in FIG. 3, the first system body 510 may include a first seal cutout 514 that includes the first planar seal face 512 and the second system body 520 may include a second seal cutout 524 which includes the second planar seal face 522 to create a seal cavity 550 that accommodates the ring seal 10. The first system body 510 may have a first system body face 515 that couples directly to a second system body face 525 on the second system body 520, or the first system body face 515 may be separated from the second system body face 525 by a retainer 50.

The ring seal 10 includes an annularly shaped body element 12 having an axial aligned center hole 14 for permitting the passage of gases or fluids. The ring seal 10 includes a radial inner surface 16 a radial outer surface 18 a first axial end surface 20 and a second axial end surface 22. Each of these surfaces may take any number of configurations. They may be substantially flat and planar, or substantially curved. The ring seal 10 may be made of any sufficiently malleable material, and can include a unitary metallic material selected from the group consisting of a stainless steel alloy a chromium alloy, a nickel alloy, commercially pure nickel, a copper alloy, and commercially pure copper, a unitary metallic material substantially identical to type 316 series stainless steel alloy, a unitary polymer material selected from the group consisting of polypropylene (PP), polyvinylidene fluoride (PVDF), perfluoroalkoxy polymer (PFA), polytetrafluoroethylene (PTFE), polychlorotrifluoroethylene (PCTFE), and polyimide, or a unitary polymer material substantially identical to polyimide.

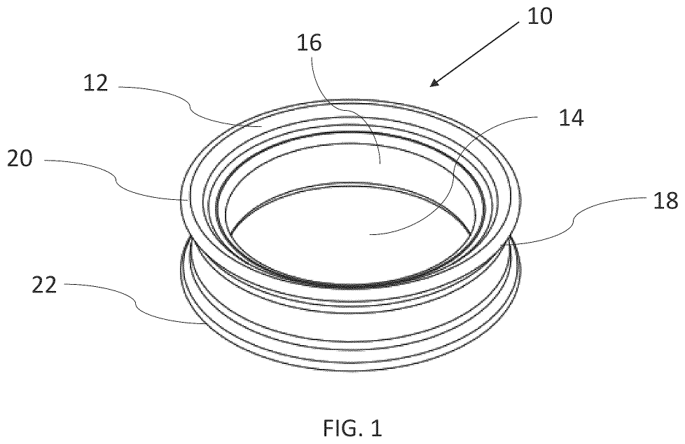

As shown in FIG. 1, radial cross-section of the seal provides particular sealing capabilities for different fluid flow environments. The radial inner surface 16 includes a flat region 24 for efficient fluid flow and curved regions 26. The curved regions 26 help form a first wing 30a that contacts the first planar seal face 512 to affect the seal. The wing 30 includes a sealing surface 34, an apex 36 where the radial inner surface 16 and the radial outer surface 18 intersect, and a wing trough 38 on the radial outer surface 18 of the wing 30. The radial outer surface 18 also comprises a central trough 40 that may also serve as a retainer holding groove to accommodate the retainer 50. The wing trough 38 and the central trough 40 may be separated by a peak 44. In a particular embodiment, the radial outer surface 18 is symmetrical about the center of the central trough 40 to form a second wing 30b that contacts the second planar seal face 522. Alternatively, the second axial end surface 22 may include an exterior chamfer blending into the radial outer surface 18 for convenience. A sealing region initially flat in a radial direction, suitable for use with fluid delivery elements having annular projections surrounding circular conduit openings, is formed as a circumferential sector generally perpendicular with respect to the center hole axis and parallel to the plane of the second axial end surface 22.

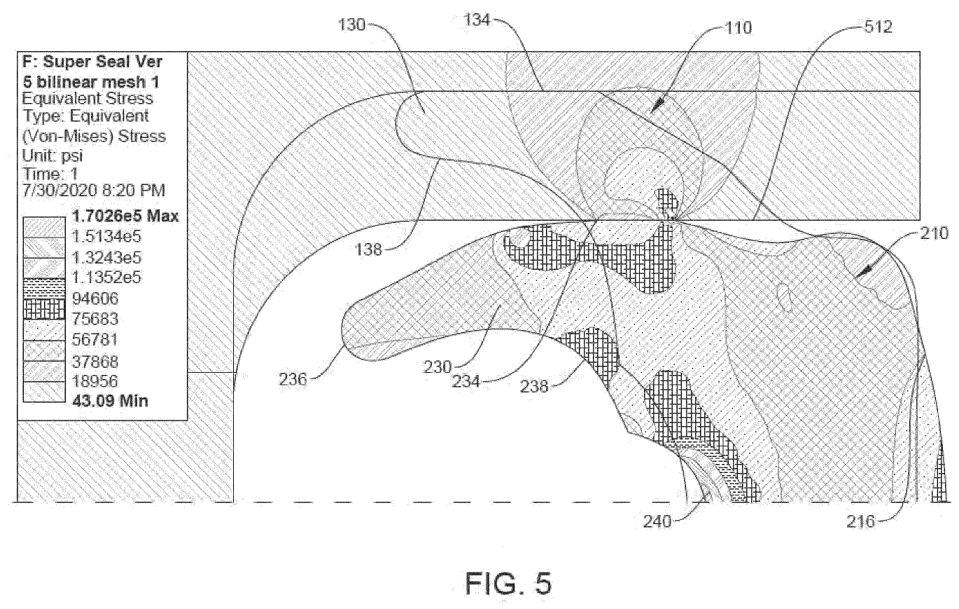

Referring now to FIG. 5, the ring seal 10 is shown as an uncompressed ring seal 110 and a compressed ring seal 210 with the colored areas expressing the stress put on the compressed ring seal 210 when the ring seal 210 is compressed between the first planar seal face 512 and the second planar surface 33. The uncompressed ring seal 110 shows the uncompressed wing 130, and the uncompressed contact surface 134. The compressed wing seal includes a compressed wing 230, a compressed contact surface 234, a compressed wing trough 238 and a compressed central trough 240.

As shown in FIG. 5, when the ring seal 10 is axially compressed between opposing planar seal faces 512, 522, the wing 230 is plastically deformed and the sealing surface 234 slightly deflected radially inward in concert with further axial compression, because of troughs 238, 240. That is, the shape of the wing 230 allows the sealing surface 234 to move along the wing 230 in a radially inward direction from closer to the apex 236 to closer to the radial inner surface 216. The peak 244 between troughs 238 and 240 effectively allows the stress to be shared between the wing trough 238 and the central trough 240, with most of the stress borne by the central trough 240 where the ring seal 210 is thickest and may be reinforced by the retainer 42.

The seal cavity 550 may be configured to limit the deformation of the ring seal 10 when compressed by configuring the wall of the seal cavity 550 to be contacted by the apex 236 when the ring seal 10 is compressed a desired amount or the seal cavity may be larger than the ring seal to allow greater flexibility of the ring seal in different stress environments such as intermittent heat and/or vibration to which the fluid delivery system 500 may be subjected. The retainer 50 may project into the seal cavity to contact the ring seal 10 at the central trough 240 or may reside within the central trough 240 without contacting the ring seal 10.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. The terms “including” and “such as” are not limiting and should be interpreted as “including, but not limited to,” and “such as, for example,” respectively. Moreover, any combination of the above-described embodiments in all possible variations thereof is encompassed by the disclosure unless otherwise indicated herein or otherwise clearly contradicted by context.

### REFERENCE SIGNS LIST

| No. | Element | No. | Element |
|---|---|---|---|
| 10 | ring seal | 134 | uncompressed contact surface |
| 12 | annularly shaped body | 210 | compressed ring seal |
| | element | | |
| 14 | center hole | 230 | compressed wing |
| 16 | radial inner surface | 234 | compressed contact surface |
| 18 | radial outer surface | 236 | apex |
| 20 | first axial end surface | 238 | compressed wing trough |
| 22 | second axial end surface | 240 | compressed central trough |
| 24 | flat region | 244 | peak |
| 26 | curved regions | 500 | fluid delivery system |
| 30 | wing | 510 | first system body |
| 33 | second planar surface | 512 | first planar seal face |
| 34 | sealing surface | 514 | first seal cutout |
| 36 | apex | 515 | first system body face |
| 38 | wing trough | 520 | second system body |
| 40 | central trough | 522 | second planar seal face |
| 42 | retainer | 524 | second seal cutout |
| 44 | peak | 525 | second system body face |
| 50 | retainer | 550 | seal cavity |
| 110 | uncompressed ring seal | 30a | first wing |
| 130 | uncompressed wing | 30b | second wing |

1. A ring gasket system for joining opposed fluid conduit ports, the ring gasket comprising:
an annularly shaped body comprising:
a center hole for permitting the passage of gases or fluids, a radial inner surface and a radial outer surface;
a wing comprising a sealing surface, an apex where the radial inner surface intersects the radial outer surface, and a wing trough on the radial outer surface of the wing;
a central trough separated from the wing trough by a peak
wherein the apex is the point most radially distant from the radial inner surface.

2. The ring gasket system of claim 1, further comprising a retainer, wherein the central trough is configured to encompass the retainer.

3. (canceled)

4. The ring gasket system of claim 1, wherein the sealing surface moves radially inward when the ring gasket is axially compressed.

5. The ring gasket system of claim 1 wherein the annularly shaped body is comprised of one or more compositions selected from the group of a stainless steel alloy, a chromium alloy, a nickel alloy, commercially pure nickel, a copper alloy, commercially pure copper, a unitary metallic material substantially identical to type 316 series stainless steel alloy, a unitary polymer material selected from the group consisting of polypropylene (PP), polyvinylidene fluoride (PVDF), perfluoroalkoxy polymer (PFA), polytetrafluoroethylene (PTFE), polychlorotrifluoroethylene (PCTFE), and polyimide, or a unitary polymer material substantially identical to polyimide.

6. The ring gasket system of claim 1 wherein the majority of the stress upon compression of the wing is on the material about the central trough.

7. The ring gasket system of claim 6 wherein the ring gasket further comprises a retainer that reinforces the central trough.

8. The ring gasket system of claim 1 further comprising a retainer that is configured to fit within the central trough to hold the seal in place.

9. The ring gasket system of claim 1 wherein at least one of the wing trough and the central trough are substantially U shaped or substantially V shaped.

10. (canceled)

11. The ring gasket system of claim 4, wherein the seal surface allows full seal surface contact from 20% of compression range to 100% of compression range.

12. The ring gasket system of claim 1, wherein the opposed fluid conduit ports are coupled to a substantially flush surface having a cavity that forms a seal cavity having a first side wall and a second side wall opposing the first side wall and wherein the radial seal size is smaller than the distance between opposing seal cavity side walls.

13. A method of forming a fluid joint in a fluid delivery system having a first system body with a first body face and a second system body with a second body face, wherein the first body face has a first cutout comprising a first seal surface and the second body face has a second cutout comprising a second seal surface and wherein the first cutout and the second cutout together form a seal cavity, the method comprising:
placing in the first cutout an annularly shaped body comprising a center hole for permitting the passage of gases or fluids, a radial inner surface, a radial outer surface, a central trough, and a wing comprising a sealing surface, an apex where the radial inner surface intersects the radial outer surface, and a wing trough on the radial outer surface of the wing, wherein the wing trough is separated from the central trough by a peak and wherein the apex is the point most radially distant from the radial inner surface;
securing a retainer to at least one of the first system body and the second system body, wherein the retainer is shaped to reside in the central trough of the annularly shaped body;
securing the first system body to the second system body such that the annularly shaped body is compressed between the first seal surface and the second seal surface.

14. The method of claim 13, wherein the annularly shaped body is compressed from about 20% of compression range to about 100% of compression range.

15. The method of claim 13, further comprising coupling the fluid conduit ports to a substantially flush surface having a cavity that forms a seal cavity having a first side wall and a second side wall opposing the first side wall wherein the radial seal size is smaller than the distance between opposing seal cavity side walls.

16. The method of claim 13, wherein the radial outer surface is symmetrical about the center of the central trough.

17. The method of claim 13 wherein the sealing surface moves radially inward when the ring gasket is axially compressed.

18. The method of claim 13, further comprising selecting a material for the annularly shaped body from one or more compositions selected from the group of a stainless steel alloy, a chromium alloy, a nickel alloy, commercially pure nickel, a copper alloy, commercially pure copper, a unitary metallic material substantially identical to type 316 series stainless steel alloy, a unitary polymer material selected from the group consisting of polypropylene (PP), polyvinylidene fluoride (PVDF), perfluoroalkoxy polymer (PFA), polytetrafluoroethylene (PTFE), polychlorotrifluoroethylene (PCTFE), and polyimide, or a unitary polymer material substantially identical to polyimide.

19. The method of claim 13, further comprising placing a majority of the stress upon compression of the wing on the material about the central trough.

20. The method of claim 13 further comprising reinforcing the central trough with a retainer.

21. The method of claim 13 further comprising holding the annularly shaped body in place at the center of a fluid path with a retainer.

22. The method of claim 13 further comprising securing a retainer configured to reside within the central trough to the second system body.

23. The method of claim 22 wherein the retainer is secured with a pin or bolt.
